(19) United States
(12) Patent Application Publication
(10) Pub. No.: US 2010/0185838 A1
(43) Pub. Date: Jul. 22, 2010

(54) PROCESSOR ASSIGNING CONTROL SYSTEM AND METHOD

(75) Inventor: FEI-HSU CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/413,589

(22) Filed: Mar. 29, 2009

(30) Foreign Application Priority Data
Jan. 16, 2009 (CN) 200910300229.6

(51) Int. Cl. G06F 9/30

(52) U.S. Cl. 712/227; 712/E09.032

(57) ABSTRACT

A processor assigning control system includes a first memory to store a plurality of control instructions and loading schedules, a second memory to temporarily store the plurality of control instructions and loading schedules, a real-time clock (RTC), and a main controller. The main controller includes a hardware detecting unit, a software obtaining unit, and a management unit. The RTC is configured for sending clock signal to make the hardware detecting unit detect whether a plurality of processors are in a normal state or an error state. The processor assigning control system is capable of detecting connection statues between the plurality of processor and a communication bus, and performance of the processors, to obtain and assign the control instructions to the corresponding processors to dynamically deploy the processors.

### BACKGROUND

1. Technical Field

The present disclosure relates to assigning control systems and assigning control methods, and more particularly, to a processor assigning control system and a processor assigning control method.

2. Description of the Related Art

Industry controllers, such as numerical control machines, are often controlled and operated by a plurality of high speed processors. These processors communicate with one another to allocate tasks so as to improve throughput of the industry controllers. Allocating tasks among the processors is often accomplished by a complicated set of control instructions. Thus, there is room for improvement in the art.

### BRIEF DESCRIPTION OF THE DRAWINGS

FIG. 1 is a block diagram of an exemplary embodiment of a processor assigning control system.

FIG. 2 is a flowchart of an exemplary embodiment of a processor assigning control method of the processor assigning control system of FIG. 1.

### DETAILED DESCRIPTION

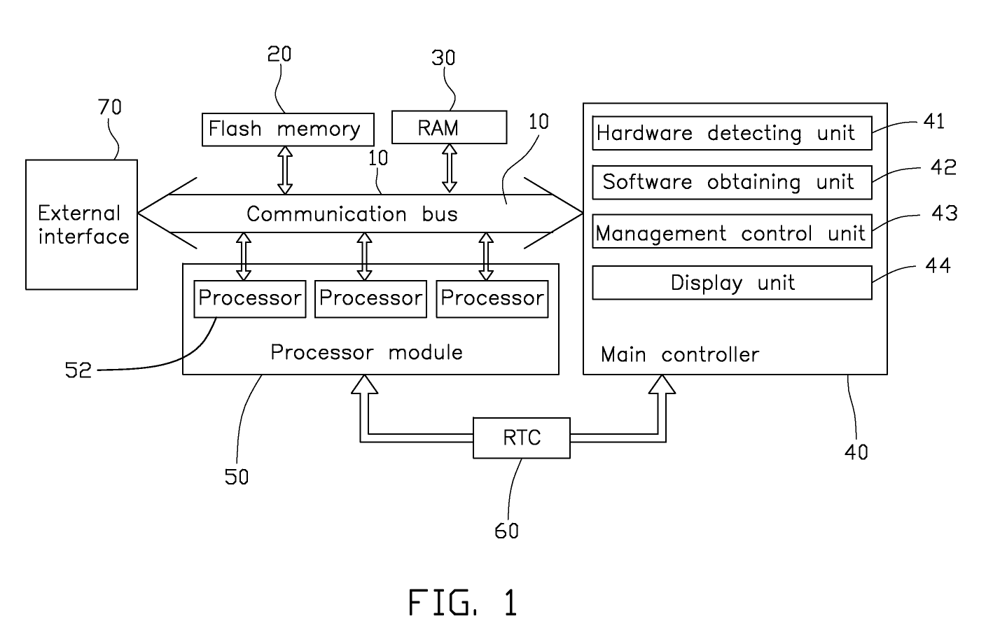

Referring to FIG. 1, an exemplary embodiment of a processor assigning control system includes a first memory such as a flash memory 20, a second memory such as a random access memory (RAM) 30, a main controller 40, a processor module 50, and a real-time clock (RTC) 60.

The processor module 50 includes a plurality of processors 52. The main controller 40 is connected to the RAM 30, the flash memory 20, and each of the plurality of processors 52, and also connected to an external interface 70 for transmitting data to the external interface 70 via a communication bus 10. The RTC 60 is also connected to each of the plurality of processors 52 and the main controller 40. In some embodiments, the processor assigning control system can include a plurality of the processor modules 50. However, for simplicity and for the purpose of explanation, only one of the processor module 50 is described as an example. The RTC 60 is connected to each processor 50 in each of the plurality of processor modules 50.

The flash memory 20 is configured for storing a plurality of control instructions, and a plurality of loading schedules to assign the plurality of control instructions to corresponding processors 52.

The RTC 60 is configured for sending clock signals to the main controller 40 and the plurality of processors 52.

The main controller 40 includes a hardware detecting unit 41, a software obtaining unit 42, a management control unit 43, and a display unit 44.

The hardware detecting unit 41 is configured for detecting connection statuses between the plurality of processors 52 and the communication bus 10, and determining the connection status of each of the processor 52 with the communication bus 10. The connection determination status between each of the plurality of processors 52 with the communication bus may be in a normal state or an error state, and may be determined by detecting whether the clock signals sent to the plurality of processors 52 are synchronous with the clock signals sent to the main controller 40. If the clock signal sent to one of the plurality of processors 52 is synchronous with the clock signal sent to the main controller 40, the connection status between the processor 52 and the communication bus 10 is in a normal state and the processors 52 are in a normal state. If the clock signal sent to one of the plurality of processors 52 is not synchronous with the clock signal sent to the main controller 40, the connection status is in an error state, and the processor 52 is in an error state. The hardware detecting unit 41 is also configured for detecting performance and data processing time of the processors 52 in the normal state, and determining workload statuses of the processors 52 connected to the communication bus 10 in the normal state according to the data processing time.

The software obtaining unit 42 is configured for reading control instructions for the processors 52 in the normal state from the flash memory 20, reading load schedules from the flash memory 20, and temporarily storing the control instructions and the loading schedules in the RAM 30.

The management control unit 43 is configured for invoking the loading schedules stored in the RAM 30 to assign the control instructions to the corresponding processors 52, and dynamically assigning the control instructions to the processors 52 according to the performance and the workload of the processors 52. Namely, the management control unit 43 dynamically assigns the control instructions to make the processors 52 that are not fully utilized or in an idle state, to execute another task or work with other processors 52. It may be understood that the term, “not being fully utilized” means that an activity workload of the processors 52 is less than 90 percent, in one example. Likewise, the term “idle” is defined as a workload of the processors being substantially constant over time. In one example, the idle state may be defined as an activity workload of the processors being less than 10 percent.

The display unit 44 is configured for displaying the processors 52 having the error state via a monitor(not shown).

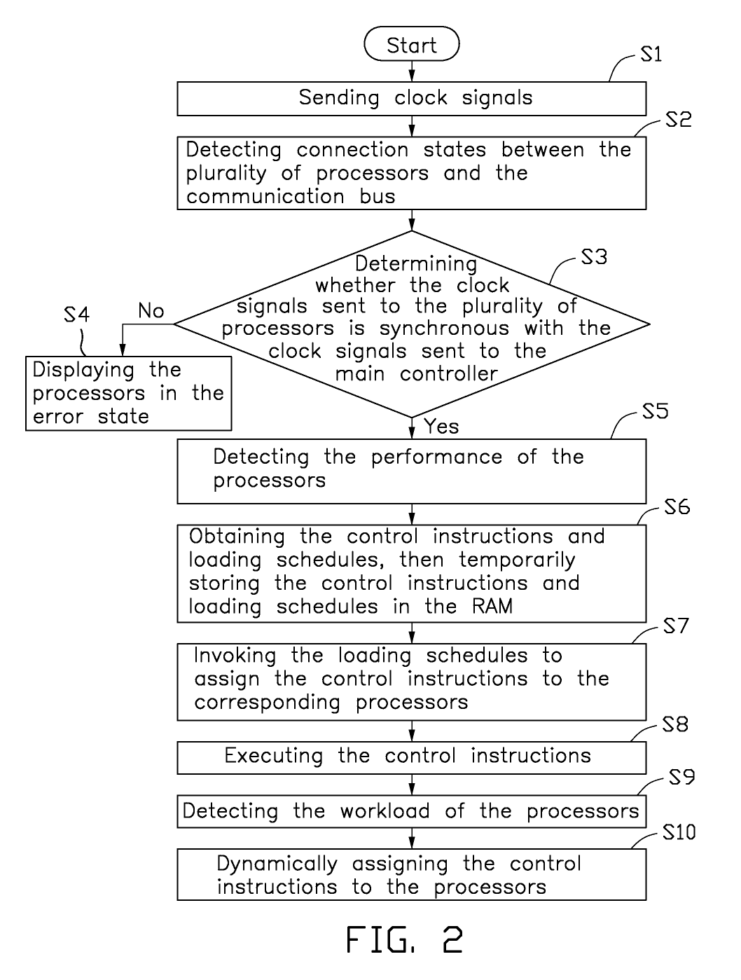

Referring to FIG. 2, an exemplary processor assigning control method includes the follow steps.

In step 1, the RTC 60 sends clock signals to the main controller 40 and each of the plurality of processors 52.

In step 2, the hardware detecting unit 41 of the main controller 40 detects connection statues between the plurality of processors 52 and the communication bus 10.

In step 3, the hardware detecting unit 41 determines whether the clock signals sent to the plurality of processors 52 connected to the communication bus 10 is synchronous with the clock signals sent to the main controller 40.

In step 4, if the clock signals sent to one of the plurality of processors 52 is not synchronous with the clock signals sent to the main controller 40, the processor 52 is in the error state. The display unit 44 displays the processor 52 in the error state via the monitor.

In step 5, if the clock signals sent to the plurality of processors 52 is synchronous with the clock signals sent to the main controller 40, the processors 52 is in the normal state. The hardware detecting unit 41 detects the performance of the processors 52.

In step 6, the software obtaining unit 42 obtains the control instructions of the corresponding processors 52 in the normal state and loading schedules from the flash memory 20 via the communication bus 10, then temporarily stores the control instructions and the loading schedules in the RAM 30.

In step 7, the management control unit 43 invokes the loading schedules from the RAM 30 to assign the control instructions to the corresponding processors 52 in the normal state according to the detected performance of the processors 52 in the normal state.

In step 8, the processors 52 in the normal state execute the control instructions.

In step 9, the hardware detecting unit 41 detects the workload of the processors 52 in the normal state.

In step 10, the management control unit 43 dynamically assigns the control instructions to the processors 52 in the normal state and being not fully utilized or in an idle state, to execute another task or work with other processors 52.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A processor assigning control system for dynamically deploying a plurality of processors connected to a communication bus, comprising:
a first memory to store a plurality of control instructions executed by the plurality of processors, and a plurality of loading schedules assigning the plurality of control instructions to the corresponding processors;
a second memory to temporarily store the plurality of control instructions and loading schedules;
a real-time clock to output clock signals; and
a main controller comprising:
a hardware detecting unit to detect connection statues between the plurality of processors and the communication bus, determine whether the plurality of processors are in a normal state or in an error state via detecting whether the clock signals sent to the plurality of processors is synchronous with the main controller, detect performance of the processors in the normal state, and determine workload of the processors in the normal state;
a software obtaining unit to obtain the control instructions of the corresponding processors in the normal state and loading schedules from the first memory and storing the obtained control instructions and loading schedules in the second memory; and
a management control unit to invoke the loading schedules stored in the second memory to assign the control instructions to the corresponding processors, and dynamically assigning the control instructions to the processors according to the workload of the processors in the normal state.

2. The processor assigning control system of claim 1, wherein the first memory is a flash memory, and the second memory is a random access memory.

3. A processor assigning control method comprising:
sending clock signals to a plurality of processors and a main controller;
detecting connection statues between the plurality of processors and a communication bus;
detecting whether the plurality of processors are in a normal state or in an error state via detecting whether the clock signals sent to the plurality of processors are synchronous with the main controller;
detecting performance of the processors in the normal state;
obtaining control instructions of the corresponding processors in the normal state and corresponding loading schedules;
invoking the loading schedules to assign the control instructions to the corresponding processors in the normal state according to the performance of the processor;
executing the control instructions;
detecting workload of the processors in the normal state; and
dynamically assigning the control instructions to the processors in the normal state according to the workload of the processors.

4. The method of claim 3, wherein the processors are in a normal state if the clock signals sent to the plurality of processors are synchronous with the clock signals sent to the main controller, and wherein the processors are in an error state if the clock signals sent to one of the plurality of processors are not synchronous with the clock signals sent to the main controller.

5. The method of claim 3, wherein the step of dynamically assigning the control instructions to the processors in the normal state comprises:
dynamically assigning the control instructions to the processors that are not being fully utilized or in an idle state, to execute another task or to work with other processors.
